(19) United States
(12) Patent Application Publication
(10) Pub. No.: US 2020/0277078 A1
(43) Pub. Date: Sep. 3, 2020

(54) ELECTRICAL POWER SYSTEM FOR AIRCRAFT HAVING HYBRID-ELECTRIC PROPULSION SYSTEM

(71) Applicant: Pratt & Whitney Canada Corp., Longueuil (CA)

(72) Inventors: Andrew D. Smith, Rock Island, IL (US); Kyle Ives, Loves Park, IL (US); Zubair A. Baig, East Hartford, CT (US)

(73) Assignee: Pratt & Whitney Canada Corp., Longueuil (CA)

(21) Appl. No.: 16/707,669

(22) Filed: Dec. 9, 2019

Related U.S. Application Data
(60) Provisional application No. 62/812,655, filed on Mar. 1, 2019.

(51) Int. Cl. B64D 35/02; B64D 27/24

(52) U.S. Cl. CPC B64D 35/02; B64D 2221/00; B64D 27/24

(57) ABSTRACT

An electrical power system is disclosed for an aircraft having a hybrid-electric propulsion system, which includes a battery assembly for storing energy, an electric motor controller operatively connected to the battery assembly for conditioning and controlling power to an electric motor, and an electric motor receiving power through the motor controller for delivering torque to a shaft of the hybrid-electric propulsion system.

### CROSS REFERENCE TO RELATED APPLICATIONS

This application claims the benefit of and priority to U.S. Provisional Patent Application No. 62/812,655, filed Mar. 1, 2019, the disclosure of which is hereby incorporated by reference in its entirety.

### BACKGROUND OF THE INVENTION

### 1. Field of the Invention

The subject invention is directed to an electrical power system, and more particularly, to an electrical power system for an aircraft having a hybrid-electric propulsion system.

### 2. Description of Related Art

The level of air traffic continues to increase worldwide, leading to increased fuel consumption and air pollution. Consequently, efforts are underway to make aircraft more environmentally compatible through the use of specific types of fuel and/or by reducing fuel consumption through the use of more efficient drive systems.

For example, aircraft having mixed drive systems that include a combination of various types of engines are known for reducing pollutants and increasing efficiency. Some current combinations include reciprocating engines and jet engines, reciprocating engines and rocket engines, jet engines and rocket engines, or turbojet engines and ramjet engines.

While these mixed drive systems are useful, they are not readily adaptable for use on commercial passenger aircraft. However, hybrid-electric propulsion systems that provide power through a combustion engine and an electric motor are indeed adaptable for use with commercial passenger aircraft and can provide efficiency benefits including reduced fuel consumption. The subject invention is directed to an aircraft having such a propulsion system, and to an electrical power system associated with an electric motor of that propulsion system.

### SUMMARY OF THE DISCLOSURE

The subject invention is directed to a new and useful electrical power system for an aircraft having a hybrid-electric propulsion system. The electric power system includes a battery assembly for storing energy, an electric motor controller operatively connected to the battery assembly for conditioning and controlling power to an electric motor, and an electric motor receiving power through the motor controller for delivering torque to a shaft of the hybrid-electric propulsion system. It is envisioned that power would be distributed in this electrical power system using High Voltage Direct Current (HVDC) to reduce power losses in distribution.

The electrical power system further comprises a battery management system for monitoring and controlling the battery assembly, and a contactor coil for disconnecting the battery assembly from the electric motor controller. It is envisioned that the battery assembly would be ungrounded with respect to the aircraft. It is further envisioned that the battery management system would control the contactor only during a condition of battery system failure. It is also envisioned that contactor could contain a pre-charge circuit to ensure the system remains service ready, or the pre-charge circuit could be incorporated into the battery assembly itself.

Preferably, a thermal fuse is located between the electric motor controller and the electric motor, and a current sensor is operatively associated with the electric motor to detect an overcurrent condition. In addition, means are preferably provided for disconnecting the electric motor from the output shaft to protect the motor in the event of a system failure condition (e.g., line to ground fault).

The electric motor controller is operatively associated with an engine control unit of the aircraft to provide redundant control of the delivery of power to the electric motor. The electric motor controller is also operatively associated with the means for disconnecting the electric motor from the output shaft in the event of a system failure condition. It is envisioned that the electric motor controller would be grounded with respect to the aircraft.

The architecture of the electric motor controller can vary depending upon the design criteria of the application. For example, in an embodiment of the invention, the digital circuitry of the electric motor controller architecture could include a series of programmable electronic memory components or the like. In another embodiment of the invention, the digital circuitry of the electric motor controller could include a field-programmable gate array (FPGA). In yet another embodiment of the invention, the digital circuitry of the electric motor controller could also include a digital signal processor (DSP) designed to improve the accuracy and reliability of digital communications.

It is envisioned that the electric motor controller would have certain conventional features to the extent that it utilizes a three level inverter topology to convert DC power from the battery assembly into Pulse Width Modulation (PWM) to control the speed of the electric motor by varying the switching frequency.

In addition, it is envisioned that the electric motor controller would be configured to control current and frequency to the electric motor to control torque output to the shaft. It would also be configured to provide electric power system protections and to communicate with the battery management system. The electric motor controller would also be configured to provide information to the pilot and flight engineer relating to system performance and health, and it is also configured to perform backup torque command calculations in case of ECU failure based on PLA input.

In accordance with a preferred embodiment of the subject invention, the electric motor is operatively associated with a heat engine, and together these two power sources define a hybrid electric propulsion system. It is envisioned that the electric motor would be designed to produce a sufficient amount of shaft power suitable for a particular engine configuration or aircraft.

It is envisioned that the electric motor and the heat engine of the hybrid-electric propulsion system could be arranged in a parallel drive configuration or in an in-line drive configuration. It is also envisioned that power may be evenly split between the electric motor and the heat engine, or it may be proportionally divided between the two electric motor and the heat engine. For example, in certain application, the electric motor may provide a lower percentage of the overall power relative to the heat engine, or vice versa.

These and other features of the electrical power system of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those having ordinary skill in the art will readily understand how to make and use the subject invention without undue experimentation, preferred embodiments thereof will be described in detail herein below with reference to the figures wherein:

FIG. 1 is a side elevational view of an aircraft that includes a hybrid-electric propulsion system operatively associated with the electrical power system of the subject invention;

FIG. 2 is a schematic representation of the hybrid-electric propulsion system associated with the electrical power system of the subject invention; and

FIG. 3 is a schematic representation of the electrical power system of the subject invention.

### DETAILED DESCRIPTION OF THE PREFERRED EMBODIMENTS

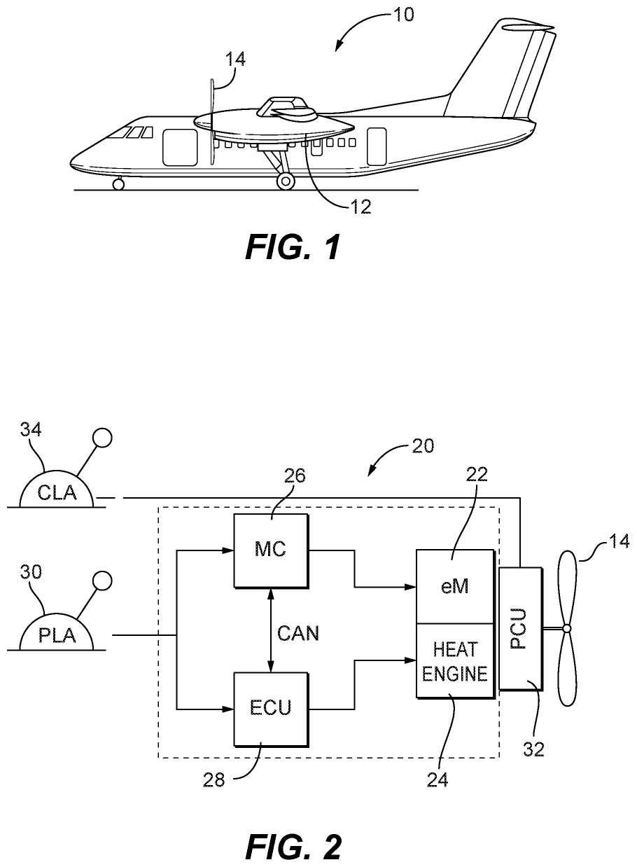

Referring now to the drawings wherein like reference numeral identify similar structure or features of the subject invention, there is illustrated in FIG. 1 a commercial aircraft 10 that includes an engine nacelle 12 housing a propulsion system that delivers power to an air mover or propeller 14 to propel the aircraft 10.

In accordance with a preferred embodiment of the subject invention, the propulsion system in engine nacelle 12 is a hybrid electric propulsion system, which is shown schematically in FIG. 2 and is designated generally by reference numeral 20. The hybrid-electric propulsion system 20 has an electric motor 22 and a heat engine 24 that deliver power to an air mover or propeller 14. The electric motor 22 and the heat engine 24 of the hybrid-electric propulsion system 20 can be arranged in a parallel drive configuration or an in-line drive configuration, depending upon the application and/or aircraft. Power can be evenly split between the electric motor 22 and the heat engine 24 (i.e., a split of 50% electric motor power and 50% heat engine power), or power can be divided proportionally between the electric motor 22 and the heat engine 24 (e.g., any split from 10% electric motor power to 90% heat engine power or vice versa).

The hybrid-electric propulsion system 20 shown in FIG. 2, further includes a Motor Controller (MC) 26 and an Engine Control Unit (ECU) 28 which communicate with one another by way of communication BUS or a similar network or communication system. The hybrid electric propulsion system 20 receives control input from the pilot by way of a Power Lever Angle (PLA) throttle 30 or through a similar electronic or mechanical input control feature. The hybrid-electric propulsion system 20 further includes a Propeller Control Unit (PCU) 32 that receives input from the pilot by way of a Condition Lever Angle (CLA) throttle 34 or a similar electronic or mechanical input control feature.

It is envisioned that the electric motor 22 would be designed to provide sufficient shaft power suitable for a particular engine configuration or aircraft. It is further envisioned that the heat engine 24 of the hybrid-electric propulsion system 20 could be a heat engine of any type e.g., a gas turbine, spark ignited, diesel, rotary or reciprocating engine of any fuel type and with any configuration of turbomachiney elements, either turbocharger, turbosupercharger, supercharger and exhaust recovery turbo compounding, either mechanically, electrically, hydraulically or pneumatically driven. An example of a rotary engine suitable for this application is disclosed in U.S. Pat. No. 10,145,291, the disclosure of which is herein incorporated by reference in its entirety.

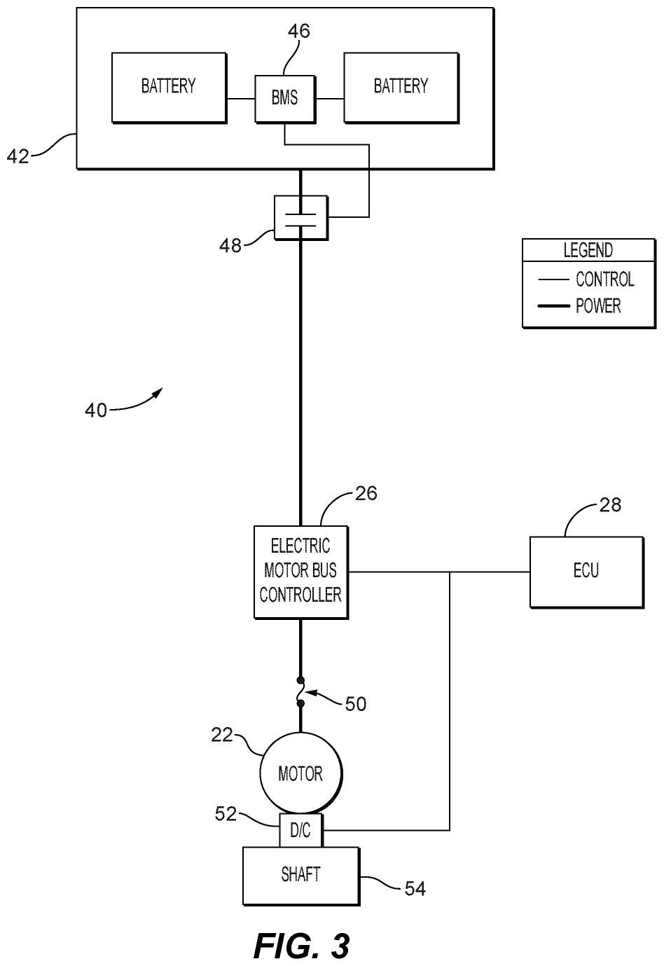

Referring now to FIG. 3, the hybrid-electric propulsion system 20 is operatively associated with an electrical power system 40, which directs and controls the flow of power thereto. Moreover, in the electrical power system 40, power is distributed using HVDC. Utilizing HVDC results in reduced power losses in power distribution.

The electrical power system 40 of the hybrid electric propulsion system 20 of includes a battery assembly 42 including a plurality of battery cells for storing power. The battery cells can be rechargeable. The power system 40 further includes an electric motor 22 that receives power from the battery assembly 42 and delivers torque to an output shaft 44 of the hybrid-electric propulsion system 20. The power system 40 further includes an electric motor controller 26 that is operatively connected to the battery assembly 42 and the electric motor 22 for conditioning and controlling power to the electric motor 22.

The electrical power system 40 of the subject invention is adapted and configured so the electrical motor controller 26 is cable of handling the full voltage range of the battery (i.e., from 100% SoC to depletion of the battery). It is also envisioned that the line voltage delivered to the electric motor 22 could be AC voltage. It is further envisioned that the power system 40 may be adapted and configured with a circuit to pre-charge the electrical motor controller 26 so that it remains service ready.

The electrical power system 40 further includes a battery management system 46. The battery management system 46 is adapted and configured to monitor battery system conditions (e.g., state of charge, state of health, temperature, etc.) and control battery system functions (e.g., power distribution amongst power cells, thermal management, cell balancing, recharging, etc.). It is further envisioned that the power system 40 may be adapted and configured with a circuit to pre-charge the electrical motor controller 26 so that it remains service ready.

A contactor 48 is provided for disconnecting the battery assembly 42 from the electric motor controller 26 when the batteries are taken offline when the electric power lane of the hybrid-electric propulsion system is off, as well as in the event of an emergency condition. It is further envisioned that the pre-charge circuit could be incorporated into contactor 48. It is also envisioned that the battery assembly 42 would be ungrounded with respect to the aircraft 10. It is further envisioned that the battery management system 46 would control the contactor 48 only during a condition of battery system failure. Otherwise, the contactor 48 would be controlled manually by the pilot or through the motor controller 26 or the ECU 28.

Preferably, the power system 40 includes a thermal fuse 50 or a similar mechanism located in the power lane between the electric motor controller 26 and the electric motor 22, which will open in the event a system fault occurs which creates an overcurrent condition. The power system 40 also includes a current sensor that is operatively associated with the electric motor 22 to detect or otherwise sense an overcurrent condition. In addition, a device 52 is provided for disconnecting the electric motor 22 from the shaft 54 to protect the electric motor 22 in the event of an unfavorable operating condition, such as, for example, an overcurrent condition or a line to ground fault condition.

The electric motor controller 26 is operatively associated with the ECU 28 of the aircraft 10 to provide redundant control of the delivery of power to the electric motor 22 in the event that the motor control 26 fails or is disrupted. The electric motor controller 26 is also operatively associated with the device 54 for disconnecting the electric motor 22 from the shaft 54 in the event of a system failure or unfavorable operating condition. It is envisioned that the electric motor controller 26 would be grounded with respect to the aircraft 10.

The architecture of the electric motor controller 26 can vary depending upon the design criteria of the application. For example, in an embodiment of the invention, the digital circuitry of the electric motor controller 26 could include a series of programmable electronic memory components or the like. In another embodiment of the invention, the digital circuitry of the electric motor controller 26 could include a field-programmable gate array (FPGA). In yet another embodiment of the invention, the digital circuitry of the electric motor controller 26 could also include a digital signal processor (DSP) designed to improve the accuracy and reliability of digital communications.

It is envisioned that the electric motor controller 26 would have certain conventional features to the extent that it utilizes a three level inverter topology to convert DC power from the battery assembly into Pulse Width Modulation (PWM) to control the speed of the electric motor 22 by varying the switching frequency.

In addition to such conventional features, it is envisioned that the electric motor controller 26 would be configured to control current and frequency to the electric motor 22 to control torque output to the shaft 54. It would also be configured to provide electric power system protections (e.g., feeder cable protection) and to communicate with the battery management system 46. The electric motor controller 26 would be also configured to provide information to the pilot and flight engineer relating to system performance and health, and it would also be configured to perform backup torque command calculations in case of failure of the ECU 28 based on input from PLA 30. It is also envisioned that the electrical motor controller 26 could be configured to control or otherwise adjust the torsional dynamics between the electric motor 22 and the heat engine 24.

While the subject disclosure has been shown and described with reference to preferred embodiments, those skilled in the art will readily appreciate that changes and/or modifications may be made thereto without departing from the scope of the subject disclosure.

What is claimed is:

1. An electrical power system for an aircraft having a hybrid-electric propulsion system, comprising:
a) a battery assembly for storing energy;
b) an electric motor controller operatively connected to the battery assembly for conditioning and controlling power to an electric motor; and
c) an electric motor receiving power through the motor controller for delivering torque to a shaft of the hybrid-electric propulsion system.

2. An electrical power system as recited in claim 1, wherein the battery assembly is rechargeable.

3. An electrical power system as recited in claim 1, wherein power is distributed in the system using High Voltage Direct Current (HVDC).

4. An electrical power system as recited in claim 1, further comprising a battery management system for controlling and monitoring the battery assembly.

5. An electrical power system as recited in claim 4, further comprising a contactor coil for disconnecting the battery assembly from the electric motor controller.

6. An electrical power system as recited in claim 5, wherein the battery management system controls the contactor during a condition of a battery system failure, but under other conditions the contactor is controlled in another manner.

7. An electrical power system as recited in claim 1, wherein the electric motor controller is operatively associated with an engine control unit of the aircraft to provide redundant control of the delivery of power to the electric motor.

8. An electrical power system as recited in claim 1, wherein the electric motor controller is grounded to the aircraft.

9. An electrical power system as recited in claim 1, wherein the electric motor controller is ungrounded.

10. An electrical power system as recited in claim 1, wherein the electric motor controller has an architecture with digital circuitry that could include programmable electronic components, field-programmable gate array (FPGA) and/or a digital signal processor (DSP)

11. An electrical power system as recited in claim 1, wherein a thermal fuse is located between the electric motor controller and the electric motor.

12. An electrical power system as recited in claim 1, wherein a current sensor is operatively associated with the electric motor to detect an overcurrent condition.

13. An electrical power system as recited in claim 1, further comprising means for disconnecting the electric motor from the shaft.

14. An electrical power system as recited in claim 13, wherein the electric motor controller is operatively associated with the means for disconnecting the electric motor from the shaft.

15. An electrical power system as recited in claim 1, wherein the electric motor controller is configured to control current and frequency to the electric motor to control torque output to the shaft.

16. An electrical power system as recited in claim 1, wherein the electric motor controller is configured to provide electric power system protections.

17. An electrical power system as recited in claim 1, wherein the electric motor controller is configured to communicate with the battery management system.

18. An electrical power system as recited in claim 1, wherein the electric motor controller is configured to provide information to the pilot and flight engineer relating to system performance and health.

19. An electrical power system as recited in claim 1, wherein the electric motor controller is configured to perform backup torque command calculations in case of ECU failure based on PLA input.

20. An electrical power system as recited in claim 1, wherein the electric motor is operatively associated with a heat engine in a hybrid-electric propulsion system.

21. An electrical power system as recited in claim 20, wherein the electric motor and the heat engine are arranged in a parallel drive configuration.

22. An electrical power system as recited in claim 20, wherein the electric motor and the heat engine are arranged in an in line drive configuration.

23. An electrical power system as recited in claim 1, wherein the electric motor controller utilizes a three level inverter topology.
